(19) United States
(12) Patent Application Publication
(10) Pub. No.: US 2018/0141070 A1
(43) Pub. Date: May 24, 2018

(54) APPLICATION DEVICE, COATING SYSTEM AND METHOD FOR COATING OBJECTS

(71) Applicant: EISENMANN SE, Boeblingen (DE)

(72) Inventors: Jan Reichler, Konstanz (DE); Ralph Meier, Waldenbuch (DE)

(21) Appl. No.: 15/573,514

(22) PCT Filed: May 4, 2016
(86) PCT No.: PCT/EP2016/000728

§ 371 Date: Nov. 13, 2017

(30) Foreign Application Priority Data
May 13, 2015 (DE) 10 2015 006 161.5

(51) Int. Cl. B05B 12/08; B05B 13/04; B05B 3/10

(52) U.S. Cl. CPC B05B 12/085; B05B 13/0431; B05B 1/005; B05B 3/1014; B05B 13/0452

(57) ABSTRACT

An application device having an application unit for coating objects, wherein the application unit has one or more rotatable components, and wherein at least one measurement device is provided, which is designed to detect vibrations of the application unit. A corresponding coating system having one or more application devices for coating objects is also provided, as well as a method for coating objects using an application unit, wherein vibrations of the application unit are detected by at least one measurement device. A fault present on the application unit, for example a detached bell cup or a turbine defect, can be detected in a particularly reliable manner and within a relatively short time.

The invention relates to an application device comprising an application unit for coating objects, the application unit having one or more rotatable components.

The invention also relates to a coating system comprising one or more application devices for coating objects by means of at least one application unit which has one or more a rotatable components.

Furthermore, the invention relates to a method for coating objects by means of an application unit.

DE 10 2012 014 212 A1 discloses an application system for coating objects by means of an application unit which comprises a high-speed rotary atomizer.

DE 10 2010 052 684 B4 discloses a method for coating objects with a paint. Here, the paint is atomized by means of a rotary atomizer which has an atomization element which rotates about an axis of rotation and is operatively connected to a drive device.

WO2011/035887 deals with the avoidance of malfunctions of rotary atomizers of an application unit, including corresponding coating defects, which can be caused by the undesired loosening of the fixing of a bell element of the rotary atomizer. In order to be able to detect the undesired loosening of a bell cup, it is proposed in WO2011/035887 to provide fluidically active design elements for generating a definable local air stream and to measure generated flow components by means of a flow sensor or a back-pressure sensor. The disadvantage in this case is, amongst other things, the relatively high constructional outlay. Furthermore, such constructional measures can have a detrimental effect on the flow conditions of the application unit, for example also on flow conditions which are critical for the application of a paint.

The object of the present invention is to develop the prior art further and to permit the detection of malfunctions of an application unit with increased reliability.

This object is achieved by an application device of the type mentioned at the beginning, wherein at least one measuring device which is designed to detect vibrations of the application unit is provided. In this way, a fault, in particular if this is caused by rotatable components, can be detected particularly reliably and within a relatively short time.

For instance, with regard to simple retrofitting capability, it may be expedient if the measuring device is constructed as a microphone.

In order to further improve the reliability in the detection of faults, it may be advantageous to provide a directional microphone as measuring device.

The reliability can be improved further if the directional microphone is designed to be movable.

Advantageously, the measuring device can be designed to pick up structure-borne sound or as a vibration sensor, preferably in the form of an acceleration meter. In this way, different faults of the application unit can be detected particularly reliably.

It may be constructionally advantageous if a handling unit carrying the application unit is equipped with the measuring device.

Alternatively or additionally, the application unit can be equipped with the measuring device.

Preferably, the measuring device can be arranged on a housing part of the application device.

In an advantageous refinement, a cleaning device for the application unit can be equipped with the measuring device.

It may be expedient if the measuring device is arranged in a cleaning chamber of the cleaning device. In this way, for example, environmental influences on the measurement can be reduced.

The object of the invention is also achieved by a coating system of the type mentioned at the beginning, wherein at least one measuring device is provided to detect vibrations of the at least one application unit. The advantages of the coating system result to the greatest possible extent in accordance with the advantages of the application device.

The object of the invention is also achieved by a method of the type mentioned at the beginning, wherein vibrations of the application unit are detected by means of at least one measuring device. The advantages according to the method result to the greatest possible extent in a manner analogous to the advantages of the application device.

Advantageously, natural frequency values of the application unit can be determined with the aid of measured values which are detected by means of the measuring device. In this way, for example, resonance harmonics, which permit conclusions as to the causes of faults, can be detected reliably. Depending on the cause of a fault, such a conclusion may possibly even be possible at an early time, i.e. even before the occurrence of the actual fault.

Preferably, vibrations of the application unit can be detected in at least one working position of the application unit by means of the measuring device. In this way, for example, reliable detection of faults can be carried out during continuous operation.

It may be expedient to move the application unit into a defined measurement position, wherein vibrations of the application unit in this measurement position are detected by means of the measuring device. In this way, for example, particularly easily comparable measured values can be recorded for the detection of faults.

In an application unit which can be moved into a cleaning position, in which the application unit can be cleaned by means of a cleaning device, it may be advantageous to detect the vibrations of the application unit in the cleaning position.

Further advantageous refinements of the invention can be gathered from the following description. Exemplary embodiments of the invention, without being restricted thereto, are explained in more detail by using the drawing in which, in a simplified, schematic illustration:

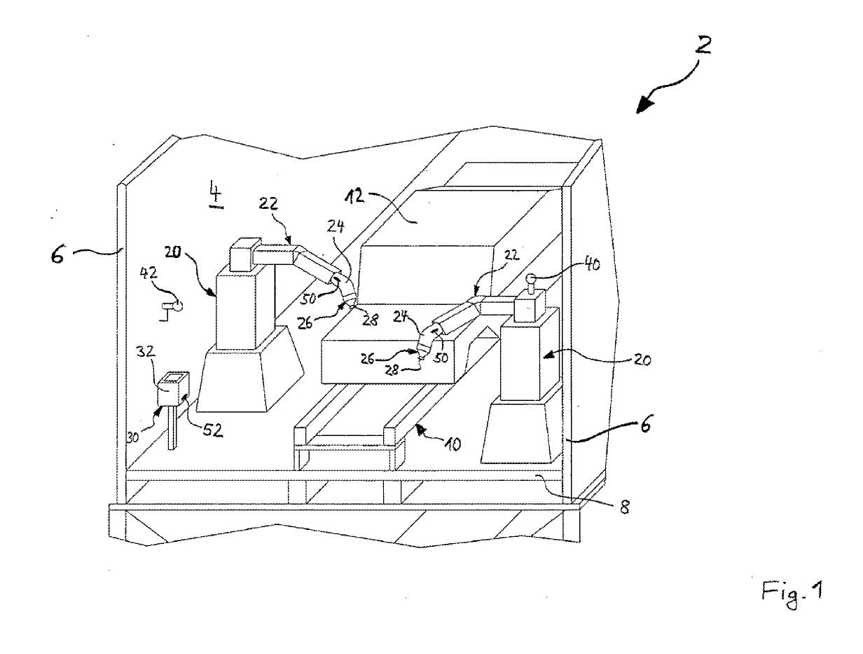

FIG. 1 shows a perspective view of part of a coating system.

FIG. 1 shows, as an example of a coating system 2, a painting system in which objects 12 are provided with a coating in the form of a paint. In the example shown, vehicle bodies are shown as objects 12 to be coated. The objects 12 to be coated can also be, for example, parts of vehicle bodies or other workpieces.

By way of example, FIG. 1 shows a perspective view of a section of a painting tunnel 4. The painting tunnel 4 shown comprises two parallel side walls 6 which, in a region no longer illustrated in the drawing, can be closed by end walls, wherein these end walls can have doors or airlocks for the objects 12 in a known manner. In the example shown, the bottom 8 of the painting tunnel 4 is formed substantially by a grating which rests on a steel structure. The upper cover of the painting tunnel 4, not specifically illustrated, can be formed in such a way, at least in some sections, that conditioned air can be led into the interior of the painting tunnel 4.

The objects 12 to be coated are moved with the aid of a conveying system 10. Thus, for example, vehicle bodies can be moved through the interior of the painting tunnel 4 in a continuous or intermittent movement.

In the coating system 2, the objects 12 to be coated are provided with a coating with the aid of an application system which has one or more application devices. An application device can, for example, be a machine, for example a ceiling machine or a side machine, or a robot, for example an industrial robot or an articulated arm robot. An application device has one or more application units 24. In particular in the case of a robot, one or more handling units 22, which carry at least one application unit 24, can be provided.

In the example shown, a plurality of application robots 20 are provided as application devices which provide the objects 12 to be coated with a coating in the form of a paint. In an application robot 20, a robot arm can be provided as movable handling unit 22, which carries the application unit 24 and, as indicated in the example shown, can be implemented in articulated form.

In order to remove contaminants from the application devices and in particular from the associated application units 24, cleaning devices 30 can be provided, which, for example, can be arranged close to a side wall 6. The cleaning device 30 shown in the example has a cleaning chamber 32, merely indicated in the drawing, into which the application unit 24 can at least partly dip. In the cleaning chamber 32, the application unit 24 dipping in can be cleaned, wherein contaminants adhering to the application unit 24 are removed.

As indicated in FIG. 1, the application units 24 can have a rotary atomizer 26, which is equipped with rotatable components such as, for example, a bell cup 28. The rotating bell cup 28 discharges coating medium in the form of a spray jet cloud. The spray jet cloud can be matched to the conditions of the object 12 to be coated and/or to the coating to be achieved. The bell cup 28 used in a rotary atomizer 26 can differ, for example with regard to its geometry and/or its dimension, in particular its diameter. As drive device for the bell cup 28, the rotary atomizer 26 can have a turbine, not specifically illustrated, which, for example, can be designed to be air-borne.

In application units 24 which are formed as application robots 20, for example as articulated arm robots, a high-speed rotary atomizer, which is characterized by a turbine output with a particularly high rotational speed, can preferably be provided as a rotary atomizer 26.

FIG. 1 shows, schematically and in a simplified illustration, a number of examples of measuring devices 40, 42, 50, 52 by means of which vibrations of the application units 24 can be measured. An application unit 24 can be assigned one or more measuring devices 40, 42, 50, 52. The measuring devices 40, 42, 50, 52 can be formed, for example, as microphones and/or as measuring devices for structure-borne sound and/or as vibration sensors which, for example, can be present in the form of acceleration meters. Such vibration sensors are known under the term accelerometer or else seismometer.

The microphone used can be, for example, a directional microphone, which can, where appropriate, be designed to be movable in order, for example, to follow the movement of an application unit 24. Directional microphones can be used, for example, when measurements are to be carried out in at least one working position of the application unit 24.

Measurements in a working position of the application unit 24 can be carried out during the coating. Alternatively or additionally, the application unit 24 can be moved into a measurement position for the measurement. A measurement position of an application unit 24 can, for example, be designed to lie closer to a measuring device 40, 42 formed as a microphone than a working positions of the corresponding application unit 24.

Measurements can also be made in or on a cleaning device 30. In order, for example, to carry out measurements in a cleaning position, a measuring device 52 can, for example, be arranged on a housing of the cleaning device 30. It is also possible for a measuring device, not specifically illustrated, to be provided in the cleaning chamber 32 of the cleaning device 30.

Measuring devices 40, 50, can for example, be arranged to be connected to an application device. Alternatively or additionally, measuring devices 42 can be arranged in another way in the coating system 2, for example arranged on a side wall 6 or connected to a side wall 6 of the painting tunnel 4.

The application unit 24 and/or the handling unit 22 of an application device can also be equipped with one or more measuring devices 50. A measuring device 50 can constructionally beneficially be arranged in or on a robot arm.

The measuring device 50 can, for example, be arranged on a housing part of the application device, for example at a suitable point of a metal housing of a robot arm. The provision of a measuring device in or on the handling unit 22 or connected to the housing of the handling unit 22 can be particularly expedient for measuring structure-borne sound.

With the aid of the measuring devices 40, 42, 50, 52, resonant frequencies of rotatable parts of the application unit 24 can be determined. By means of the measuring devices 40, 42, 50, 52, the resonances of rotatable parts of the application unit 24 are detected. Such rotatable parts are, for example, the turbine of the application unit 24 or its shaft and the bell cup 28. It is possible to distinguish resonances which are typical of the operation of the application unit 24 with and without a specific bell cup 28. The corresponding resonant frequencies differ on the basis of the different moved masses. Thus, the natural frequency of the turbine with and without bell cup 28 can differ after passing through a critical rotational speed, that is to say therefore at the latest after the end of application. By means of the rapid detection of a fault such as a loosened or loosening bell cup or else a turbine defect, fewer components will be erroneously coated and it is possible for coating medium, for example paint, to be saved.

A concept on which the invention is based can be summarized as follows: The present invention relates to an application device comprising an application unit 24 for coating objects 12, wherein the application unit 24 has one or more rotatable components, and wherein at least one measuring device 40, 42, 50, 52, which is designed to detect vibrations of the application unit 24, is provided. The invention also relates to a corresponding coating system 2 having one or more application devices for coating objects 12, and a method for coating objects 12 by means of an application unit 24, wherein vibrations of the application unit 24 are detected by means of at least one measuring device 40, 42, 50, 52. With the aid of the vibration measurements, natural frequency values of the application unit 24 can be determined, which permit reliable conclusions about the condition of rotatable components of the application unit 24. According to the invention, a fault present on the application unit 24, for example a loosened bell cup or a turbine defect, can be detected particularly reliably and within a comparatively short time.

Likewise, specific vibration profiles for the application operation of different process parameters for existing application units 24 can be created. The frequency response of an application unit 24 depends, amongst other things, on process parameters such as pressure and temperature and/or the type of the coating material to be applied. During the commissioning of a coating system, calibration runs can be carried out under real conditions, in which the vibration behavior and vibration values of the application device 24 are monitored and recorded as a vibration profile. If appropriate, such vibration profiles can also be created by a simulation.

Even small deviations from the stored vibration profile can provide an indication that a significant fault is developing and the application unit 24 can be checked for this and serviced if appropriate. In addition, the vibration values detected during the operation, in correlation with the stored vibration profile, can permit conclusions to be drawn within the context of a statistical evaluation about the quality of the coating obtained as a result. For example, the wear of the application unit 24 dependent on an applied color can be determined.

What is claimed is:

1. An application device comprising:
an application unit for coating objects, the application unit having one or more rotatable components, wherein
at least one measuring device which is designed to detect vibrations of the application unit, is provided.

2. The application device as claimed in claim 1, wherein the measuring device is a microphone.

3. The application device as claimed in claim 2, characterized in that wherein the microphone is constructed as a directional microphone.

4. The application device as claimed in claim 3, wherein the directional microphone is designed to be movable.

5. The application device as claimed in claim 1, wherein the measuring device is designed to pick up structure-borne sound or as a vibration sensor, preferably in the form of an accelerated meter.

6. The application device as claimed in claim 1, further comprising a handling unit carrying the application unit, the handling unit being equipped with the measuring device.

7. The application device as claimed in claim 1, wherein the application unit is equipped with the measuring device.

8. The application device as claimed in claim 1 further comprising a housing part, wherein the measuring device is arranged on the housing part.

9. The application device as claimed in claim 1 wherein a cleaning device for the application unit is provided, the cleaning device being equipped with the measuring device.

10. The application device as claimed in claim 9, wherein the measuring device is arranged in a cleaning chamber of the cleaning device.

11. A coating system comprising:
one or more application devices for coating objects by means of at least one application unit which has one or more rotatable components,
wherein
at least one measuring device is provided to detect vibrations of the at least one application unit.

12. A method for coating objects comprising:
coating objects by means of an application unit,
wherein
vibrations of the application unit are detected by means of at least one measuring device.

13. The method as claimed in claim 12, wherein natural frequency values of the application unit are determined with the aid of measured values which are detected by means of the measuring device.

14. The method as claimed in claim 12, wherein the vibrations of the application unit are detected in at least one working position of the application unit.

15. The method as claimed in claim 12, wherein the application unit is moved into a defined measurement position, and is that the vibrations of the application unit in the measurement position are detected.

16. The method as claimed in claim 12, wherein the application unit is moved into a cleaning position, in which the application unit can be cleaned by means of a cleaning device, and in that the vibrations of the application unit in the cleaning position are detected.
